(19) United States
(12) Patent Application Publication
(10) Pub. No.: US 2026/0194989 A1
(43) Pub. Date: Jul. 9, 2026

(54) JOYSTICK DEVICE AND ELECTRONIC EQUIPMENT

(71) Applicant: Chipsemi Semiconductor (NingBo) Co., Ltd., Ningbo (CN)

(72) Inventors: Kejia LIU, Ningbo (CN); Yaoguo ZHANG, Ningbo (CN); Yibin WU, Ningbo (CN); Bo NIE, Ningbo (CN); Yongfeng SANG, Ningbo (CN); Guanchun JIANG, Ningbo (CN)

(21) Appl. No.: 19/557,087

(22) Filed: Mar. 4, 2026

Related U.S. Application Data
(63) Continuation of application No. PCT/CN2025/137530, filed on Nov. 25, 2025.

(30) Foreign Application Priority Data
Dec. 17, 2024 (CN) 202411861721.1

(51) Int. Cl. G06F 3/0338; A63F 13/24

(52) U.S. Cl. CPC G06F 3/0338; A63F 13/24

(57) ABSTRACT

The present disclosure relates to the field of angle measurement technology and discloses a joystick device and an electronic equipment. The joystick device of the present disclosure includes: a joystick, a rocker arm structure, a processor, a circuit board, and an upper cover; a receiving cavity is formed between the upper cover and the circuit board, and a limiting hole is provided on a side of the upper cover away from the circuit board; one end of the joystick is connected to the rocker arm structure, and the other end of the joystick extends out of the upper cover through the limiting hole. The rocker arm structure has a plurality of rotating shafts, and at least one rotating shaft is provided with a first rotating portion.

### CROSS REFERENCE TO RELATED DISCLOSURES

This application is a continuation of PCT Patent Application No. PCT/CN2025/137530, entitled “JOYSTICK DEVICE AND ELECTRONIC EQUIPMENT,” filed November 25, 2025, which claims priority to Chinese Patent Disclosure No. 2024118617211, entitled “JOYSTICK DEVICE AND ELECTRONIC EQUIPMENT,” filed on December 17, 2024, each of which is incorporated by reference herein in its entirety.

### TECHNICAL FIELD

This disclosure relates to the field of angle measurement technology, and in particular to a joystick device and an electronic equipment.

### BACKGROUND

Currently, joysticks have wide applications in fields such as medical devices, drone control handles, and game controllers. For example, position control of medical devices, orientation control on drone control handles, and position control on game controllers. At this stage, higher requirements have also been put forward for the accuracy of angle measurement of joystick rotation.

In the related art, the rotation angle of a joystick is mainly detected by sensors. Common sensors include Hall sensors, carbon film sensors, etc. Hall sensors have problems such as being susceptible to external magnetic interference and having a non-linear relationship between signal and distance. Carbon film sensors have problems such as contact wear and low detection accuracy. Therefore, the technical solution of achieving joystick angle measurement through sensor detection has low accuracy and cannot meet users' increasingly higher demands for the accuracy of joystick angle measurement.

### SUMMARY

The embodiments of the present disclosure are intended to provide a joystick device and an electronic equipment, thereby improving the accuracy of angle measurement of the joystick device.

To solve the above technical problems, in some embodiments of the present disclosure, a joystick device is provided. The joystick device includes: a joystick, a rocker arm structure, a processor, a circuit board, and an upper cover covering the circuit board. The upper cover and the circuit board define a receiving cavity, and the upper cover is provided with is provided with a limiting hole on a side away from the circuit board. The rocker arm structure is disposed inside the receiving cavity. The joystick has one end connected to the rocker arm structure, and the other end extending out of the upper cover through the limiting hole. The rocker arm structure has a plurality of rotating shafts, and at least one of the plurality of rotating shafts is provided with a first rotating portion on a side of the rocker arm structure facing the circuit board. The joystick device further includes brackets in one-to-one correspondence with the first rotating portions and provided on a first surface of the circuit board, the first surface being a surface of the circuit board close to the rocker arm structure, and the brackets are disposed inside the receiving cavity. The joystick device further includes first conductor plates are provided on surfaces of the first rotating portions facing the brackets, and first electrode plate assemblies disposed opposite to first conductor plates and provided on second surfaces of the brackets, the second surface being a surface of the bracket facing the first conductor plate. Each of the first electrode plate assemblies includes a first electrode plate and second electrode plates. The first electrode plates and the second electrode plates are electrically connected to the circuit board. The processor is connected to the circuit board. in response to a respective first conductor plate of the first conductor plates being rotated following the joystick, a relative area between the respective first conductor plate and each of the second electrode plates changes. The first electrode plate, the second electrode plates, and the respective first conductor plate form a first target capacitor. The processor is configured to obtain a capacitance value of the first target capacitor and determine a rotation direction and an angle of the joystick according to the capacitance value of the first target capacitor.

In some embodiments of the present disclosure, an electronic equipment including the aforementioned joystick device is also provided,

In some embodiments, at least one rotating shaft is further provided with a second rotating portion in a direction away from the circuit board. A second conductor plate is provided on a surface of the second rotating portion facing the bracket, and a second electrode plate assembly disposed opposite to the second conductor plate is further provided on the second surface of the bracket. the second electrode plate assembly includes a third electrode plate and fourth electrode plates. The third electrode plate and the fourth electrode plates are electrically connected to the circuit board. When the second conductor plate rotates following the joystick, a relative area between the second conductor plate and the corresponding fourth electrode plates changes. The third electrode plates, the fourth electrode plates, and the second conductor plate form a second target capacitor. The processor is further configured to obtain capacitance value of the second target capacitor and determine a rotation direction and an angular position of the joystick based at least on the capacitance value of the first target capacitor and the capacitance value of the second target capacitor.

In some embodiments, the first conductor plate, the second electrode plates, the second conductor plates, and the fourth electrode plates are of fan-shaped structures.

In some embodiments, the rocker arm structure includes a lower rocker arm and an upper rocker arm covering the lower rocker arm, the upper rocker arm rotates following the joystick along a first axis, and the lower rocker arm rotates following the joystick along a second axis, the first axis being perpendicular to the second axis. The upper rocker arm is provided with two rotating shafts along the first axis direction, and the lower rocker arm is provided with two rotating shafts along the second axis direction. A first sliding opening is provided on a side of the upper rocker arm facing the upper cover, a second sliding opening is provided on a side of the lower rocker arm facing the upper cover. positioning holes are provided on two sidewalls of the lower rocker arm perpendicular to the first surface, and positioning members in one-to-one correspondence with the positioning holes are provided at an end of the joystick connected to the rocker arm structure. The joystick passes through the first sliding opening and the second sliding opening in sequence, so that the positioning members are assembled in the positioning holes.

In some embodiments, each of the first electrode plate assembly includes a plurality of second electrode plates, and when the first conductor plate rotates following the joystick, the relative area between the respective first conductor plate and each second electrode plate changes. The respective first conductor plate, the corresponding first electrode plate, and each corresponding second electrode plate form one first target capacitor. The processor is configured to obtain capacitance values of the plurality of first target capacitors and determine the rotation directions and angular positions of the joystick according to the capacitance values of the plurality of first target capacitors.

In some embodiments, the second electrode plate assembly includes a plurality of fourth electrode plates, and when the second conductor plate rotates following the joystick, the relative area between the second conductor plate and each fourth electrode plate changes. The second conductor plate, corresponding third electrode plate, and each corresponding fourth electrode plate form one second target capacitor. The processor is further configured to obtain capacitance values of the plurality of second target capacitors and determine the rotation directions and angular positions of the joystick according to the capacitance values of the plurality of first target capacitors and the capacitance values of the plurality of the second target capacitors.

In some embodiments, among the plurality of rotating shafts, the number of rotating shafts provided with the first rotating portions and the second rotating portions is two, and the two rotating shafts have different rotation directions.

In some embodiments, each rotating shaft among the plurality of rotating shafts is provided with the first rotating portion and the second rotating portion.

In some embodiments, the joystick device further includes a button, and a dome switch is provided on a surface of the button away from the upper cover. A button area correspondingly connected to the dome switch is provided on the first surface of the circuit board.

The technical solutions provided by embodiments of the present disclosure have at least the following advantages:

In some embodiments, first conductor plates and first electrode plate assemblies are provided in the joystick device, where the first electrode plate and the second electrode plates of each of the first electrode plate assemblies are coupled through the respective first conductor plate to form a first target capacitor. In response to the joystick being rotated, the joystick drives the first conductor plates to rotate through the rotating shafts, causing the relative area between the first conductor plate and the second electrode plates in each of the first electrode plate assemblies to change, and the capacitance values of the plurality of the target capacitor formed by the first conductor plates, the first electrode plates, and the second electrode plates changes. That is, at different rotation angular positions, the capacitance values of the plurality of the first target capacitors are different, so that the rotation directions and angular positions of the joystick may be detected through the changes in the capacitance values of the plurality of first target capacitors. Compared with the sensor method of the related art, in some embodiments, angle measurement of the joystick device through capacitance detection is realized, and the rotation directions and angular positions of the joystick through changes in the plurality of first target capacitors may be accurately determined, thereby the accuracy of angle measurement of the joystick device may be improved.

### BRIEF DESCRIPTION OF THE DRAWINGS

One or more embodiments are illustrated by way of example with corresponding figures in the drawings. These exemplary illustrations do not constitute limitations on the embodiments. Elements with the same reference numerals in the drawings represent similar elements. Unless specifically stated, the figures in the drawings are not drawn to scale.

FIG. 1 is a structural schematic diagram of a joystick device according to some embodiments of the present disclosure;

FIG. 2 is a cross-sectional structural schematic diagram of a joystick device according to some embodiments of the present disclosure;

FIG. 3 is an exploded structural schematic diagram of a joystick device according to some embodiments of the present disclosure;

FIG. 4 is a partially enlarged schematic diagram of a joystick device according to some embodiments of the present disclosure;

FIG. 5 is a structural schematic diagram of a bracket and a first electrode plate assembly according to some embodiments of the present disclosure;

FIG. 6 is a planar structural schematic diagram of a first conductor plate on a first rotating portion according to some embodiments of the present disclosure;

FIG. 7 is a planar structural schematic diagram of a first electrode plate assembly on a bracket according to some embodiments of the present disclosure;

FIG. 8 is a structural schematic diagram of another joystick device according to some embodiments of the present disclosure;

FIG. 9 is a structural schematic diagram of yet another joystick device according to some embodiments of the present disclosure; and

FIG. 10 is a structural schematic diagram of a bracket of a joystick device according to some embodiments of the present disclosure.

### DETAILED DESCRIPTION

As may be seen from the background, the accuracy of joysticks in the related art is relatively low and cannot meet users' increasingly high demands for joystick accuracy.

To solve the problem of low joystick accuracy in the related art, some embodiments of the present disclosure relate to a joystick device, including: a joystick, a rocker arm structure, a processor, a circuit board, and an upper cover covering the circuit board; a receiving cavity is formed between the upper cover and the circuit board, and a limiting hole is provided on a side of the upper cover away from the circuit board; the rocker arm structure is disposed inside the receiving cavity, one end of the joystick is connected to the rocker arm structure, and the other end of the joystick extends out of the upper cover through the limiting hole; the rocker arm structure has a plurality of rotating shafts, and at least one rotating shaft is provided with a first rotating portion on a side of the rocker arm structure facing the circuit board. Brackets in one-to-one correspondence with the first rotating portions are provided on a first surface of the circuit board, the first surface being a surface of the circuit board facing the rocker arm structure. Brackets are disposed inside the receiving cavity. First conductor plates are provided on surfaces of the first rotating portions facing the brackets, and first electrode plate assemblies disposed opposite to the first conductor plates are provided on second surfaces of the brackets, the second surfaces being surfaces of the brackets facing the first conductor plates. Each of the first electrode plate assemblies includes a first electrode plate and second electrode plates. The first electrode plate and the second electrode plates are electrically connected to the circuit board. The processor is connected to the circuit board. In response to the first conductor plate being rotated following the joystick, relative areas between the first conductor plate and each of the second electrode plates changes. The first electrode plate, the second electrode plates, and the first conductor plate form a first target capacitor. The processor is configured to obtain capacitance values of a plurality of the first target capacitors and determine rotation directions and angular positions of the joystick according to the capacitance values of the plurality of first target capacitors.

In some embodiments, first conductor plates and first electrode plate assemblies are provided in the joystick device, where the first electrode plate and the second electrode plate of each of the first electrode plate assemblies are coupled through the first conductor plate to form a first target capacitor. When the joystick rotates, the joystick drives the first conductor plates to rotate through the rotating shafts, causing the relative area between the first conductor plate and the second electrode plates in each of the first electrode plate assemblies to change, and the capacitance values of the plurality of the target capacitors formed by the first conductor plates, the first electrode plates, and the second electrode plates changes. That is, at different rotation angular positions, the capacitance values of the plurality of first target capacitors are different, so that the rotation directions and angles of the joystick may be detected through the changes in the capacitance values of the plurality of first target capacitors. Compared with the sensor method of the related art, in some embodiments, angle measurement of the joystick device is realized through capacitance detection, and the rotation directions and angular positions of the joystick may be accurately determined through changes in the plurality of first target capacitors, thereby the accuracy of angle measurement of the joystick device may be improved.

To make the objectives, technical solutions, and advantages of embodiments of the present disclosure clearer, various embodiments of the present disclosure would be described in detail below in conjunction with the accompanying drawings. However, those of ordinary skill in the art should understand that many technical details are presented in various embodiments of the present disclosure to enable readers to better understand the present disclosure. However, the technical solutions claimed in the present disclosure may be implemented even without these technical details and various changes and modifications based on the following embodiments. The division of the following embodiments is for convenience of description and should not constitute any limitation on the specific implementation of the present disclosure. The various embodiments can be combined and referenced with each other without contradiction.

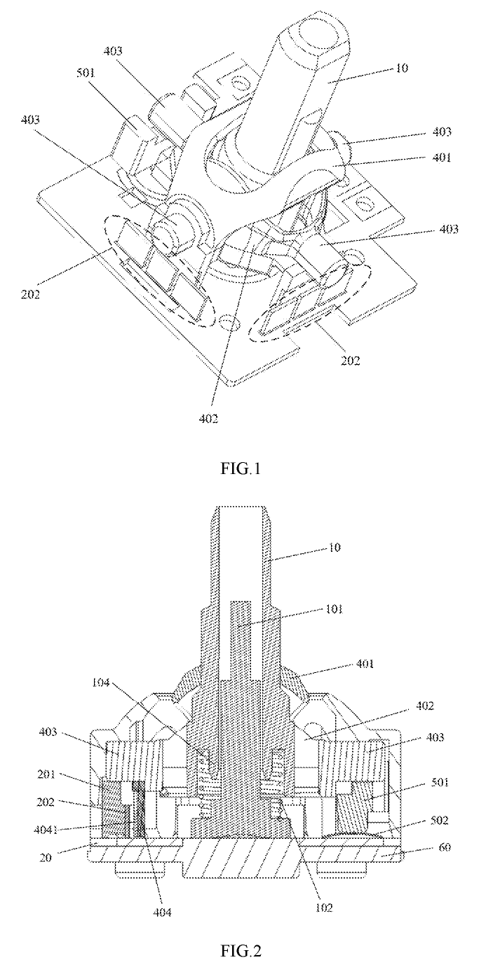

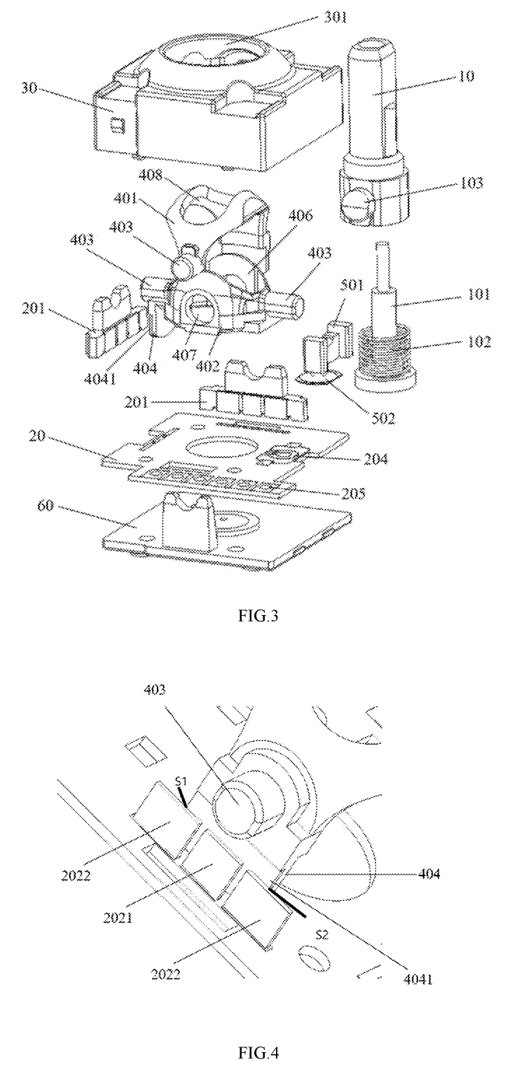

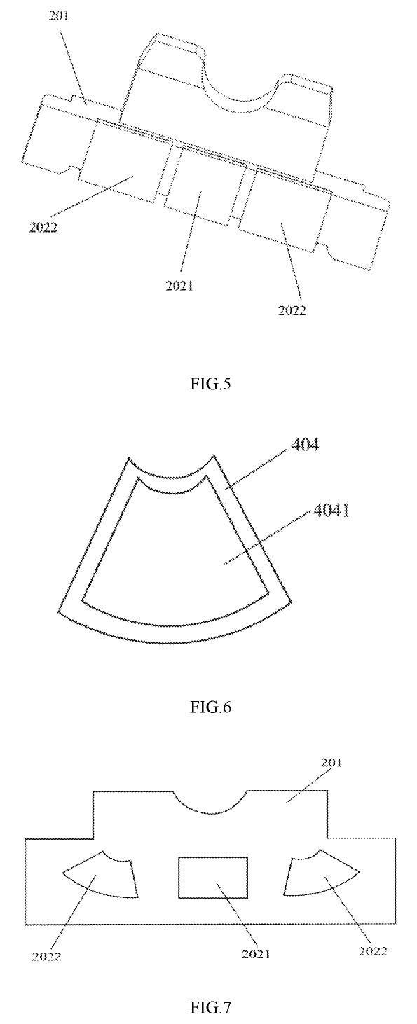

Embodiments of the present disclosure relates to a joystick device. As shown in FIG. 1, which is a structural schematic diagram of a joystick device according to embodiments of the present disclosure, as shown in FIG. 2, which is a cross-sectional structural schematic diagram of a joystick device according to embodiments of the present disclosure, as shown in FIG. 3, which is an exploded structural schematic diagram of a joystick device according to embodiments of the present disclosure, as shown in FIG. 4, which is a partially enlarged schematic diagram of a joystick device according to embodiments of the present disclosure, and as shown in FIG. 5, which is a structural schematic diagram of a bracket and a first electrode plate assembly according to embodiments of the present disclosure; the joystick device of some embodiments includes: a joystick 10, a rocker arm structure (not labeled in the figure), a processor (not labeled in the figure), a circuit board 20, and an upper cover 30 covering the circuit board 20.

Specifically, a receiving cavity is formed between the upper cover 30 and the circuit board 20, and a limiting hole 301 is provided on a side of the upper cover 30 away from the circuit board 20; the rocker arm structure (including an upper rocker arm 401 and a lower rocker arm 402) is disposed inside the receiving cavity, one end of the joystick 10 is connected to the rocker arm structure, and the other end of the joystick 10 extends out of the upper cover 30 through the limiting hole 301. The rocker arm structure has a plurality of rotating shafts 403, and at least one rotating shaft 403 is provided with a first rotating portion 404 on a side of the rocker arm structure facing the circuit board 20. Brackets 201 in one-to-one correspondence with the first rotating portions 404 are provided on a first surface of the circuit board 20. The first surface is a surface of the circuit board 20 facing the rocker arm structure. Brackets 201 are disposed inside the receiving cavity. First conductor plates 4041 are provided on surfaces of the first rotating portions 404 facing brackets 201, and first electrode plate assemblies 202 disposed opposite to the first conductor plates 4041 are provided on second surfaces of the brackets 201. The second surfaces are surfaces of the brackets 201 facing the first conductor plates 4041. Each of the first electrode plate assemblies 202 includes a first electrode plate 2021 and second electrode plates 2022. The first electrode plate 2021 and second electrode plates 2022 are electrically connected to the circuit board 20. The processor is connected to the circuit board 20. In response to the first conductor plates 4041 being rotated following the joystick 10, a relative area between a first conductor plate 4041 and corresponding second electrode plates 2022 changes. The relative area being an area of an orthographical projection of one plate on the other plate. The first conductor plate 4041, first electrode plate 2021 and second electrode plates 2022 form a first target capacitor. A plurality of PIN pins 205 are further provided on the circuit board 20 to transmit signals of a plurality of the first target capacitor received by the circuit board 20 to the processor, and the processor is configured to obtain capacitance values of a plurality of the first target capacitor and determine rotation directions and angular positions of the joystick 10 according to the capacitance values of the plurality of the first target capacitor.

Each of the brackets 201 of some embodiments has a groove at an end away from the circuit board 20, and the corresponding rotating shaft 403 is disposed in the groove. Thus, brackets 201 may also support the rotating shafts 403, improving the stability of the rocker arm structure.

The rocker arm structure of some embodiments includes a lower rocker arm 402 and an upper rocker arm 401 covering the lower rocker arm 402. The upper rocker arm 401 rotates following the joystick 10 along a first axis, and the lower rocker arm 402 rotates following the joystick 10 along a second axis. The first axis and the second axis are perpendicular to each other. The upper rocker arm 401 is provided with two rotating shafts 403 along the first axis direction, and the lower rocker arm 402 is provided with two rotating shafts 403 along the second axis direction. A first sliding opening 408 is provided on a side of the upper rocker arm 401 facing the upper cover 30, a second sliding opening 406 is provided on a side of the lower rocker arm 402 facing the upper cover 30, positioning holes 407 are provided on both sidewalls of the lower rocker arm 402 perpendicular to the first surface, and positioning members 103 in one-to-one correspondence with the positioning holes 407 are provided at an end of the joystick 10 connected to the rocker arm structure. The joystick 10 passes through the first sliding opening 408 and the second sliding opening 406 in sequence, so that the positioning members 103 are assembled in the positioning holes 407.

Specifically, during the rotation of the joystick 10, the joystick 10 may rotate in the first sliding opening 408 and drive the lower rocker arm 402 to rotate following the joystick 10 along the second axis, while the upper rocker arm 401 does not rotate. The joystick 10 may also rotate in the second sliding opening 406 and drive the upper rocker arm 401 to rotate following the joystick 10 along the first axis, while the lower rocker arm 402 does not rotate. In this way, the movement of the joystick 10 is realized. The first electrode plate 2021 and the second electrode plates 2022 corresponding to the first rotating portions 404 provided on the rotating shaft 403 of the upper rocker arm 401 are used to detect the rotation angular positions of the joystick 10 on the first axis, and the first electrode plate 2021 and the second electrode plates 2022 corresponding to the first rotating portions 404 provided on the rotating shafts 403 of the lower rocker arm 402 are used to detect the rotation angular position of the joystick 10 on the second axis, thereby realizing the detection of the rotation angular positions of the joystick 10 in various directions, and then determining the rotation directions of the joystick 10 and the rotation angular positions of the joystick 10 in the rotation directions according to the rotation angular positions in various directions.

Specifically, a base 60 is further provided on a surface of the circuit board 20 away from the joystick 10, that is, the circuit board 20 is disposed on the base 60. The base 60 provides support and protection for the circuit board 20, improving the operational stability of the circuit board 20.

Specifically, the joystick 10 of some embodiments has a cavity, and a reset rod 101 connected to the circuit board 20 is disposed in the cavity. The bottom of the reset rod 101 is connected to the circuit board 20, and the reset rod 101 is also sleeved with a spring 102. One end of the spring 102 abuts against the bottom where the reset rod 101 is connected to the circuit board 20. A limiting member 104 is provided inside the cavity of the joystick 10 to form a limiting groove. The other end of the spring 102 abuts inside the limiting groove, that is, the top of the spring 102 is disposed inside the limiting groove, realizing an elastic connection between the joystick 10 and the reset rod 101 through the spring 102. By providing the reset rod 101, the reset of the joystick 10 may be realized in some embodiments. The reset rod 101 is also sleeved with a spring 102. By sleeving the spring 102, the reset speed of the joystick 10 can be improved, and reset delay can be minimized.

The joystick device of some embodiments further includes a button 501, and a dome switch 502 is provided on a surface of the button 501 away from the upper cover 30; a button area 204 correspondingly connected to the dome switch 502 is provided on the first surface of the circuit board 20.

The button 501 has a "concave" structure, that is, a groove is provided on a side of the button 501 away from the circuit board 20. One of the rotating shafts 403 of the rocker arm structure is disposed in the groove of the "concave" structure. When the joystick 10 is pressed, the rocker arm structure presses the button 501 through this rotating shaft 403. After the button 501 is pressed, the button 501 presses the dome switch 502. The dome switch 502 functions as a switch, triggering the button area 204 in the circuit board 20 through the dome switch 502, thereby triggering the corresponding function. In practical disclosures, when a user plays a game with a game controller having the joystick 10, some scenarios require the button 501 to be used for confirmation; for example, the user needs to select a character image through the button 501. The user first selects a character image from a row of character images by moving the joystick 10 left and right, and then presses the joystick 10 downward, thereby driving the button 501 to be pressed. The button 501 then presses the dome switch 502. After being pressed, the corresponding button area 204 in the circuit board 20 is triggered, and the user selects this character image.

Continuing to refer to FIGS. 4 and 5, each of the first electrode plate assemblies 202 includes a plurality of second electrode plates 2022. FIGS. 4 and 5 illustrate an example where the number of second electrode plates 2022 is two. To obtain better detection accuracy, the number of second electrode plates 2022 can also be set to three, four, etc.

Specifically, when the first conductor plates 4041 rotate following the joystick 10, the relative area between the first conductor plate 4041 and each second electrode plate 2022 changes. The first conductor plate 4041, first electrode plate 2021, and each second electrode plate 2022 form one first target capacitor. The processor is configured to obtain capacitance values of a plurality of first target capacitors and determine the rotation directions and angular positions of the joystick 10 according to the capacitance values of the plurality of first target capacitors. The first electrode plate 2021 and each second electrode plate 2022 of some embodiments form a first target capacitor. By utilizing the relationship between the capacitance values of a plurality of first target capacitors, an algorithm may cleverly eliminate the influence of factors such as gap changes between the first electrode plate assembly 202 and the first conductor plate 4041, as well as dielectric coefficient changes, on the rotation angular position, thereby achieving better detection results. The greater the number of second electrode plates 2022, the higher the detection accuracy.

It should be noted that the first electrode plate 2021 of some embodiments is a transmitting electrode plate, and the second electrode plates 2022 are receiving electrode plates. In other embodiments, the first electrode plate 2021 may also be a receiving electrode plate, and the second electrode plate 2022 may also be transmitting electrode plates.

In one embodiment, the number of second electrode plates 2022 on a second surface of a bracket 201 disposed opposite to the first conductor plate 4041 is two. The two second electrode plates 2022 are symmetrically arranged on both sides of the first electrode plate 2021. The two second electrode plates 2022 are symmetrically arranged along a central axis of the first conductor plate 4041, and the central axis of the first conductor plate 4041 is perpendicular to the first surface of the circuit board 20.

Specifically, when the joystick 10 rotates, it drives first rotating portions 404 to rotate. Specifically, during the rotation of the first electrode plate 2021, the relative area between the first conductor plate 4041 and the two second electrode plates 2022 changes, and within a certain angular position range of the joystick 10, the relative area has a linear relationship with the rotation angular position. When the rotation angular position of the joystick 10 is 0, the relative area between the first conductor plate 4041 and one of the two second electrode plates 2022 is recorded as S1 (as shown in FIG. 4), and the relative area between the first conductor plate 4041 and the other of the two second electrode plates 2022 is recorded as S2 (as shown in FIG. 4). Since the rotation angular position of the joystick 10 is 0 at this time, the relative areas between the first conductor plate 4041 and each of the two second electrode plates 2022 are the same, so S1 and S2 are the same. The target capacitor formed by the first electrode plate 2021, the first conductor plate 4041, and one second electrode plate 2022 is recorded as C1, and the target capacitor formed by the first electrode plate 2021, the first conductor plate 4041, and the other second electrode plate 2022 is recorded as C2. According to the circuit structure and the driving and detection principles of the chip, the relationship between capacitors C1 and C2 and the rotation angular position α of the joystick 10 may be obtained as: C1 = ε(S1 - kα)/d, C2 = ε(S2 + kα)/d, where ε is the dielectric constant, k is a parameter related to the structure, and d is the distance between the first electrode plate 2021 and the second electrode plates 2022. To eliminate the influence of the dielectric constant ε and the distance d, the data of C1 and C2 can be effectively processed. For example, a Para value can be obtained through differential operation: Para = (C1 - C2)/(C1 + C2) = -kα/S1. From the finally calculated Para value, it can be seen that the influence of the dielectric constant ε and the distance d is eliminated. Some embodiments may also obtain the value of C1/C2, that is, C1/C2 = (S1 - kα)/(S2 + kα), which can also eliminate the influence of the dielectric constant ε and the distance d between the electrode plates.

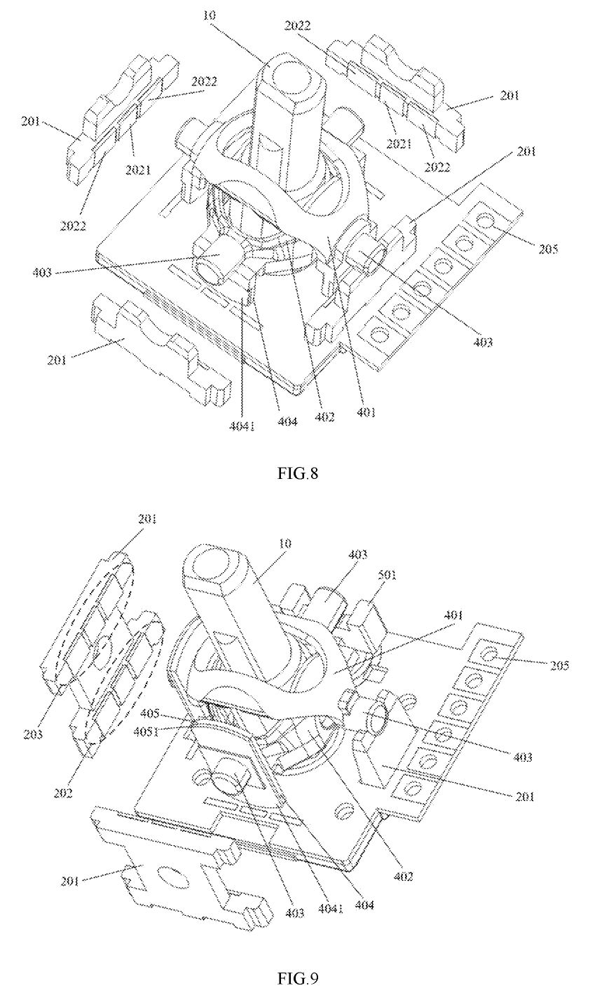

As shown in FIGS. 4 and 5, the first electrode plate 2021 and the second electrode plates 2022 are illustrated with rectangular structures as an example. To make the linearity between the target capacitors and the rotation angular positions of the joystick 10 better, the first electrode plate 2021 and the second electrode plates 2022 may both be arranged as fan-shaped structures. As shown in FIG. 6, which is a planar structural schematic diagram of a first conductor plate on a first rotating portion according to embodiments of the present disclosure, and as shown in FIG. 7, which is a planar structural schematic diagram of a first electrode plate assembly on a bracket according to embodiments of the present disclosure, since the first conductor plate 4041 and the second electrode plates 2022 are both fan-shaped structures, the centers of a plurality of fan-shaped structures overlap, and the center is disposed on the first axis or the second axis. During the rotation of the first conductor plate 4041 following the joystick 10, the relative area between the first conductor plate 4041 and each second electrode plate 2022 has a linear relationship with the rotation angular position of the joystick 10. The linearity of the Para value or the C1/C2 value calculated according to the differential operation is higher, the calculation result is more accurate, and the accuracy of angle measurement of the joystick device is further improved. It should be noted that the surface of the first rotating portion 404 on which the first conductor plate 4041 is provided may also be a fan-shaped structure.

It should be noted that the relative area between the first electrode plate 2021 and the first conductor plate 4041 of some embodiments remains fixed and unchanged. The shape of the first electrode plate 2021 may be rectangular, circular, fan-shaped, etc. Even when the first rotating portions 404 rotates following the joystick 10, the relative area between the first electrode plate 2021 and the first conductor plate 4041 does not change, so that the change in the first target capacitor is only related to the relative area between the first conductor plate 4041 and the second electrode plates 2022, further improving detection accuracy.

In some embodiments, among the plurality of rotating shafts 403, the number of rotating shafts 403 provided with the first rotating portion 404 is two, and the two rotating shafts 403 have different rotation directions.

Continuing to refer to FIGS. 1, 2, and 3, the joystick device has four rotating shafts 403, of which two rotating shafts 403 are provided by the upper rocker arm 401, and the other two rotating shafts 403 are provided by the lower rocker arm 402. The four rotating shafts 403 are respectively disposed around the rocker arm structure. In some embodiment, one of the rotating shafts 403 of the upper rocker arm 401 is provided with a first rotating portion 404, and one of the rotating shafts 403 of the lower rocker arm 402 is provided with a first rotating portion 404. These two first rotating portions 404 are disposed on two adjacent rotating shafts 403. That is, in some embodiments, a first rotating portion 404 on one rotating shaft 403 of the upper rocker arm 401 is provided to detect the rotation angular position of the joystick 10 on the first axis, and a first rotating portion 404 on one rotating shaft 403 of the lower rocker arm 402 is provided to detect the rotation angular position of the joystick 10 on the second axis, so that according to the rotation angular positions of the joystick 10 in various directions, not only the rotation direction of the joystick 10 may be determined, but also the rotation angular position of the joystick 10 in the rotation direction may be determined.

Since in some embodiments first rotating portions 404 are provided only at two rotating shafts 403, a button 501 may also be provided at the rotating shaft 403 where no rotating portion 404 is provided. As shown in FIGS. 1 and 3, one rotating shaft 403 of the lower rocker arm 402 is provided with a first rotating portion 404, and the other rotating shaft 403 is disposed in the groove of the "concave" structure of the button 501. In other embodiments, the button 501 may be provided at one rotating shaft 403 of the upper rocker arm 401, that is, one rotating shaft 403 of the upper rocker arm 401 is provided with a first rotating portion 404, and the other rotating shaft 403 is disposed in the groove of the "concave" structure of the button 501, thereby realizing the same function.

In other embodiments, among the plurality of rotating shafts 403, one rotating shaft 403 may be disposed in the groove of the "concave" structure of the button 501, and the other rotating shafts 403 are all provided with corresponding brackets 201. The brackets 201 may all be provided with first rotating portions 404, or only some brackets 201 are provided with first rotating portions 404. For example, if the rocker arm structure has four rotating shafts 403, one rotating shaft 403 is disposed in the groove of the "concave" structure of the button 501. Among the other three rotating shafts 403, each rotating shaft 403 is provided with a first rotating portion 404, and the corresponding three brackets 201 are all provided with corresponding first electrode plate assemblies 202. Alternatively, among the other three rotating shafts 403, two rotating shafts 403 are provided with first rotating portions 404, and the corresponding two brackets 201 are both provided with corresponding first electrode plate assemblies 202. The remaining one rotating shaft 403 is not provided with a first rotating portion 404, and the corresponding bracket 201 is also not provided with a corresponding first electrode plate assembly 202, but this bracket 201 also has a groove, and the remaining one rotating shaft 403 may be disposed in the groove, so that each rotating shaft 403 of the rocker arm structure has a corresponding bracket 201 or button 501 for support, improving the stability of the rocker arm structure.

In some embodiments, each rotating shaft 403 among the plurality of rotating shafts 403 is provided with a first rotating portion 404. As shown in FIG. 8, which is a structural schematic diagram of a joystick device according to some embodiments of the present disclosure, the joystick device has four rotating shafts 403, of which two rotating shafts 403 are provided by the upper rocker arm 401, and the other two rotating shafts 403 are provided by the lower rocker arm 402. The four rotating shafts 403 are respectively disposed around the rocker arm structure. In some embodiments, each rotating shaft 403 is provided with a first rotating portion 404. Correspondingly, four corresponding brackets 201 are provided on the circuit board 20. That is, in some embodiments, two rotating shafts 403 of the upper rocker arm 401 are provided with first rotating portions 404 to detect the rotation angular positions of the joystick 10 on the first axis, and two rotating shafts 403 of the lower rocker arm 402 are provided with first rotating portions 404 to detect the rotation angular position of the joystick 10 on the second axis, so that according to the rotation angular positions of the joystick 10 in various directions, not only the rotation direction of the joystick 10 may be determined, but also the rotation angular position of the joystick 10 in the rotation direction may be determined. At the same time, since in some embodiments, more first target capacitors are formed, the accuracy of angle measurement of the joystick 10 may be further improved.

In some embodiments, first conductor plates 4041 and first electrode plate assemblies 202 in the joystick device are provided. The first electrode plate 2021 and the second electrode plates 2022 of each of the first electrode plate assemblies 202 are coupled through the first conductor plate 4041 to form a first target capacitor. When the joystick 10 rotates, the joystick 10 drives the first conductor plates 4041 to rotate through the rotating shafts 403, causing the relative area between the first conductor plate 4041 and the second electrode plates 2022 in each of the first electrode plate assemblies 202 to change, and the capacitance values of the plurality of first target capacitors formed by the first conductor plate 4041, the corresponding first electrode plate 2021, and the corresponding second electrode plates 2022 changes. That is, at different rotation angular positions, the capacitance values of the plurality of first target capacitors are different, so that the rotation directions and angular positions of the joystick 10 may be detected through the changes in the capacitance values of the plurality of first target capacitors. Compared with the sensor method of the related art, angle measurement of the joystick device through capacitance detection is realized in some embodiments, and the rotation direction and angular position of the joystick 10 may be accurately determined through changes in the plurality of first target capacitors, thereby the accuracy of angle measurement of the joystick device may be improved.

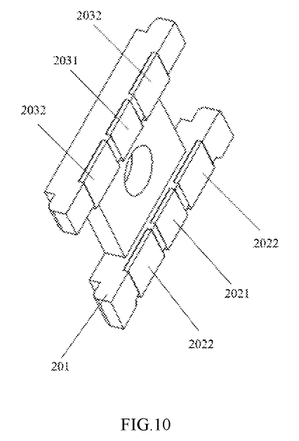

Another embodiment of the present disclosure also relates to a joystick device. As shown in FIG. 9, which is a structural schematic diagram of a joystick device according to some embodiments of the present disclosure, and as shown in FIG. 10, which is a structural schematic diagram of a bracket of a joystick device according to some embodiments of the present disclosure, the joystick device of some embodiments includes: a joystick 10, a rocker arm structure (not labeled in the figure), a processor (not labeled in the figure), a circuit board 20, and an upper cover 30 covering the circuit board 20.

Specifically, a receiving cavity is formed between the upper cover 30 and the circuit board 20, and a limiting hole 301 is provided on a side of the upper cover 30 away from the circuit board 20. The rocker arm structure (including an upper rocker arm 401 and a lower rocker arm 402) is disposed inside the receiving cavity, one end of the joystick 10 is connected to the rocker arm structure, and the other end of the joystick 10 extends out of the upper cover 30 through the limiting hole 301. The rocker arm structure has a plurality of rotating shafts 403, and at least one rotating shaft 403 is provided with a first rotating portion 404 on a side of the rocker arm structure facing the circuit board 20. Brackets 201 in one-to-one correspondence with first rotating portions 404 are provided on a first surface of the circuit board 20, the first surface being a surface of the circuit board 20 facing the rocker arm structure. Brackets 201 are disposed inside the receiving cavity. First conductor plates 4041 are provided on surfaces of the first rotating portions 404 facing the bracket 201, and first electrode plate assemblies 202 disposed opposite to the first conductor plates 4041 are provided on second surfaces of the brackets 201, the second surface being a surface of the bracket 201 facing the first conductor plate 4041. Each of the first electrode plate assemblies 202 includes a first electrode plate 2021 and second electrode plates 2022. The first electrode plate 2021 and the second electrode plates 2022 are electrically connected to the circuit board 20. The processor is connected to the circuit board 20. When the first conductor plate 4041 rotates following the joystick 10, a relative area between the each of first conductor plates 4041 and corresponding second electrode plates 2022 changes.

Specifically, at least one rotating shaft 403 is further provided with a second rotating portion 405 in a direction away from the circuit board 20. Second conductor plates 4051 are provided on surfaces of second rotating portions facing brackets 201, and second electrode plate assemblies 203 disposed opposite to the second conductor plates 4051 are further provided on second surfaces of the corresponding brackets 201. Each of the second electrode plate assemblies 203 includes a third electrode plate 2031 and fourth electrode plates 2032. The third electrode plate 2031 and the fourth electrode plates 2032 are electrically connected to the circuit board 20. When the second conductor plates 4051 rotates following the joystick 10, a relative area between each of the second conductor plates 4051 and the corresponding fourth electrode plates 2032 changes. The first electrode plate 2021, second electrode plates 2022, and each of the first conductor plates 4041 form a first target capacitor, and the third electrode plate 2031, fourth electrode plates 2032, and each of the second conductor plates 4051 form a second target capacitor. A plurality of PIN pins 205 are further provided on the circuit board 20 to transmit signals of a plurality of the first target capacitors and signals of the plurality of second target capacitors received by the circuit board 20 to the processor. The processor is configured to obtain capacitance values of the plurality of first target capacitors and capacitance values of a plurality of the second target capacitors, and determine the rotation directions and angular positions of the joystick 10 based at least on the capacitance values of the plurality of first target capacitors and the capacitance values of the plurality of second target capacitors.

The difference between some embodiments and the previous embodiment is that some embodiments further provide second rotating portions 405, second conductor plates 4051, and second electrode plate assemblies 203. The other structures of some embodiments are substantially the same as those of the previous embodiment. To avoid repetition, they would not be described again here.

Specifically, each of the second electrode plate assemblies 203 includes a plurality of fourth electrode plates 2032. FIGS. 9 and 10 illustrate an example where the number of fourth electrode plates 2032 is two. To obtain better detection accuracy, the number of fourth electrode plates 2032 may also be set to three, four, etc.

Specifically, when the second conductor plates 4051 rotate following the joystick 10, the relative area between the each of second conductor plates 4051 and each corresponding fourth electrode plate 2032 changes. The third electrode plate 2031, each of the second conductor plates 4051, and each fourth electrode plate 2032 form one second target capacitor. The processor is further configured to obtain capacitance values of the plurality of second target capacitors and determine the rotation directions and angular positions of the joystick 10 based at least on the capacitance values of the plurality of first target capacitors and the capacitance values of the plurality of second target capacitors. The third electrode plate 2031 and each fourth electrode plate 2032 of some embodiments form one second target capacitor. By utilizing the relationship between the capacitance values of the plurality of second target capacitors, an algorithm may cleverly eliminate the influence of factors such as gap changes between the electrode plate assemblies and the conductor plates, as well as dielectric coefficient changes, on the rotation angular positions, thereby achieving better detection results. The greater the number of fourth electrode plates 2032, the higher the detection accuracy.

In some embodiments, the number of fourth electrode plates 2032 on the second surface of each of the brackets 201 disposed opposite to each of the second conductor plate 4051 is two. The two fourth electrode plates 2032 are symmetrically arranged on both sides of the third electrode plate 2031. The two fourth electrode plates 2032 are symmetrically arranged along a central axis of each of the second conductor plate 4051, and the central axis of each of the second conductor plate 4051 is perpendicular to the first surface of the circuit board 20.

It should be noted that the relative area between each third electrode plate 2031 and the corresponding second conductor plate 4051 of some embodiments remains fixed and unchanged. Even when the second rotating portion 405 rotates following the joystick 10, the relative area between each third electrode plate 2031 and the corresponding second conductor plate 4051 does not change, so that the changes in the second target capacitors are only related to the relative areas between the second conductor plate 4051 and the fourth electrode plates 2032, further improving detection accuracy.

The third electrode plate 2031 of some embodiments is a transmitting electrode plate, and the fourth electrode plates 2032 are receiving electrode plates. In other embodiments, the third electrode plate 2031 may also be a receiving electrode plate, and the fourth electrode plates 2032 may also be transmitting electrode plates.

Specifically, the first conductor plates 4041, the second electrode plates 2022, the second conductor plates 4051, and the fourth electrode plates 2032 of some embodiments are all fan-shaped structures. The centers of a plurality of fan-shaped structures overlap, and the center is disposed on the first axis or the second axis. Through this arrangement, the linearity between each first target capacitor, each second target capacitor, and each rotation angular position of the joystick 10 is further improved. It should be noted that the surface of each second rotating portion 405 on which each second conductor plate 4051 is provided may also be a fan-shaped structure.

In some embodiments, among the plurality of rotating shafts 403, the number of rotating shafts 403 provided with first rotating portions 404 and second rotating portions 405 is two, and the two rotating shafts 403 have different rotation directions.

Continuing to refer to FIG. 9, in some embodiments, a second rotating portion 405 is also provided on the rotating shaft 403 where the first rotating portion 404 is provided. The joystick device has four rotating shafts 403, of which two rotating shafts 403 are provided by the upper rocker arm 401, and the other two rotating shafts 403 are provided by the lower rocker arm 402. The four rotating shafts 403 are respectively disposed around the rocker arm structure. In some embodiments, one of the rotating shafts 403 of the upper rocker arm 401 is provided with a first rotating portion 404 and a second rotating portion 405, and one of the rotating shafts 403 of the lower rocker arm 402 is provided with a first rotating portion 404 and a second rotating portion 405. These two sets of first rotating portions 404 and second rotating portions 405 are disposed on two adjacent rotating shafts 403. That is, in some embodiments, the first rotating portion 404 and the second rotating portion 405 on one rotating shaft 403 of the upper rocker arm 401 are provided to detect the rotation angular positions of the joystick 10 on the first axis, and the first rotating portion 404 and the second rotating portion 405 are provided on one rotating shaft 403 of the lower rocker arm 402 to detect the rotation angular positions of the joystick 10 on the second axis, so that according to the rotation angular positions of the joystick 10 in various directions, not only the rotation directions of the joystick 10 may be determined, but also the rotation angular positions of the joystick 10 in the rotation direction may be determined.

Since in some embodiments first rotating portions 404 and second rotating portions 405 are provided at only two rotating shafts 403, a button 501 may also be provided at the rotating shaft 403 where no rotating portion 404 is provided. As shown in FIG. 9, one rotating shaft 403 of the lower rocker arm 402 is provided with a first rotating portion 404 and a second rotating portion 405, and the other rotating shaft 403 is disposed in the groove of the "concave" structure of the button 501. In other embodiments, the button 501 may be provided at one rotating shaft 403 of the upper rocker arm 401, that is, one rotating shaft 403 of the upper rocker arm 401 is provided with a first rotating portion 404 and a second rotating portion 405, and the other rotating shaft 403 is disposed in the groove of the "concave" structure of the button 501, thereby realizing the same function.

In other embodiments, among the plurality of rotating shafts 403, one rotating shaft 403 may be disposed in the groove of the "concave" structure of the button 501, and the other rotating shafts 403 are all provided with corresponding brackets 201. The brackets 201 may all be provided with first rotating portions 404 and second rotating portions 405, or only some brackets 201 are provided with first rotating portions 404 and second rotating portions 405. For the rotating shaft 403 that is not provided with first rotating portions 404 and second rotating portions 405, the bracket 201 corresponding to that rotating shaft 403 is also not provided with a first electrode plate assembly 202 and a second electrode plate assembly 203, but this bracket 201 also has a groove, and the corresponding rotating shaft 403 may be disposed in the groove, thereby supporting the rotating shaft 403 through the corresponding rotating shaft 403 and improving the stability of the rocker arm structure.

In some embodiment, each rotating shaft 403 among the plurality of rotating shafts 403 is provided with a first rotating portion 404 and a second rotating portion 405. That is, in some embodiments, two rotating shafts 403 of the upper rocker arm 401 are provided with first rotating portions 404 and second rotating portions 405 to detect the rotation angular position of the joystick 10 on the first axis, and two rotating shafts 403 of the lower rocker arm 402 are provided with first rotating portions 404 and second rotating portions 405 to detect the rotation angular position of the joystick 10 on the second axis, so that according to the rotation angular positions of the joystick 10 in various directions, not only the rotation direction of the joystick 10 may be determined, but also the rotation angular positions of the joystick 10 in the rotation direction may be determined. At the same time, since in some embodiments, more first target capacitors and second target capacitors are formed, the accuracy of angle measurement of the joystick 10 can be further improved.

In some embodiments, second conductor plates 4051 and second electrode plate assemblies 203 in the joystick device are further provided. The third electrode plate 2031 and the fourth electrode plates 2032 of each second electrode plate assembly 203 are coupled through the second conductor plate 4051 to form a second target capacitor. When the joystick 10 rotates, the joystick 10 drives the first conductor plate 4041 and the second conductor plates 4051 to rotate through the rotating shaft 403, causing the relative area between the first conductor plate 4041 and the second electrode plates 2022 in each first electrode plate assembly 202 to change, and the relative area between the second conductor plate 4051 and the fourth electrode plates 2032 in each second electrode plate assembly 203 to change. The capacitance values of the plurality of first target capacitors formed by the first conductor plate 4041, the first electrode plates 2021, and the second electrode plates 2022 change, and the capacitance values of the plurality of the second target capacitors formed by the second conductor plate 4051, the third electrode plates 2031, and the fourth electrode plates 2032 change, so that the rotation directions and angular positions of the joystick 10 may be more accurately determined through the changes in the capacitance values of the plurality of first target capacitors and the plurality of capacitance values of the second target capacitors, further improving the accuracy of angle measurement of the joystick device.

In another aspect of some embodiments of the present disclosure, an electronic equipment including the aforementioned joystick device is also provided.

The electronic equipment in some embodiments may be a game controller, keyboard, medical device, unmanned aerial vehicle, or other equipment.

Since the electronic equipment provided by some embodiments of the present disclosure includes the joystick device of the aforementioned embodiments, it also has the technical effects provided by the aforementioned embodiments, which would not be described in detail here.

The division of the various components above is only for clear description. During implementation, they may be combined into one component or some components may be split and decomposed into a plurality of components. As long as the same logical relationship is included, all are within the protection scope of some embodiments.

Those of ordinary skill in the art may understand that the above embodiments are specific embodiments for implementing the present disclosure, and in practical disclosure, various changes may be made in form and detail without departing from the spirit and scope of the present disclosure.

What is claimed is:

1. A joystick device, comprising:
a joystick;
a rocker arm structure;
a circuit board;
a processor coupled to the circuit board; and
an upper cover over the circuit board; wherein:
the upper cover and the circuit board define a receiving cavity, and the upper cover is provided with a limiting hole on a side away from the circuit board, and the rocker arm structure is disposed inside the receiving cavity;
the joystick has one end connected to the rocker arm structure, and another end extending out of the upper cover through the limiting hole;
the rocker arm structure has a plurality of rotating shafts, and at least one of the plurality of rotating shafts is provided with a first rotating portion on a side of the rocker arm structure facing the circuit board;
the joystick device further includes brackets corresponding, respectively, to first rotating portions, and the brackets are disposed inside the receiving cavity on a first surface of the circuit board facing the rocker arm structure;
the joystick device further comprises first conductor plates provided on surfaces of the first rotating portion facing the brackets, and first electrode plate assemblies disposed opposite to the first conductor plates and provided on second surfaces of the brackets facing the first conductor plates; each of the first electrode plate assemblies comprises a first electrode plate and second electrode plates; the first electrode plate and the second electrode plates are electrically connected to the circuit board; in response to a respective first conductor plate of the first conductor plates being rotated following the joystick, a relative area between the respective first conductor plate and each of the second electrode plates changes, and a relative area between the first electrode plate and the first conductor plate remains unchanged;
the first electrode plate and the first conductor plate are of fan-shaped structures;
the first electrode plate and the second electrode plates form a first target capacitor with a respective first conductor plate of the first conductor plates; the processor is configured to obtain the capacitance value and to determine a rotation direction and an angular position of the joystick based at least on the capacitance value of the first target capacitor.

2. The joystick device according to claim 1, wherein the at least one rotating shaft is further provided with a second rotating portion in a direction away from the circuit board, a second conductor plate is provided on a surface of the second rotating portion facing the bracket, and a second electrode plate assembly disposed opposite to the second conductor plate is further provided on the second surface of the bracket, the second electrode plate assembly comprising a third electrode plate and fourth electrode plates; the third electrode plate and the fourth electrode plates are electrically connected to the circuit board; in response to the second conductor plate being rotated following the joystick, a relative area between the second conductor plate and the fourth electrode plates changes, and a relative area between the third electrode plate and the second conductor plate remains unchanged;
the third electrode plate, the fourth electrode plates, and the second conductor plate form a second target capacitor; the processor is further configured to obtain a capacitance value of the second target capacitor and determine a rotation direction and an angular position of the joystick based at least on the capacitance value of the first target capacitor and the capacitance value of the second target capacitor.

3. The joystick device according to claim 2, wherein the first conductor plates, the second electrode plates, the second conductor plates, and the fourth electrode plates are of fan-shaped structures.

4. The joystick device according to claim 1, wherein the rocker arm structure comprises a lower rocker arm and an upper rocker arm covering the lower rocker arm, the upper rocker arm rotates following the joystick along a first axis, and the lower rocker arm rotates following the joystick along a second axis, the first axis being perpendicular to the second axis;
the upper rocker arm is provided with two rotating shafts along the first axis direction, and the lower rocker arm is provided with two rotating shafts along the second axis direction;
a first sliding opening is provided on a side of the upper rocker arm facing the upper cover, a second sliding opening is provided on a side of the lower rocker arm facing the upper cover, positioning holes are provided on two sidewalls of the lower rocker arm perpendicular to the first surface, and positioning members in one-to-one correspondence with the positioning holes are provided at an end of the joystick connected to the rocker arm structure;
the joystick passes through the first sliding opening and the second sliding opening in sequence, so that the positioning members are assembled in the positioning holes.

5. The joystick device according to claim 1, wherein the first electrode plate assembly comprises a plurality of second electrode plates, and in response to the first conductor plate being rotated following the joystick, the relative area between the first conductor plate and each second electrode plate changes;
the first electrode plate, the first conductor plate, and each second electrode plate form one first target capacitor; the processor is configured to obtain capacitance values of the plurality of first target capacitors and determine the rotation directions and angular positions of the joystick based at least on the capacitance values of the plurality of first target capacitors.

6. The joystick device according to claim 2, wherein the second electrode plate assembly comprises a plurality of fourth electrode plates, and in response to the second conductor plates being rotated following the joystick, the relative area between the second conductor plate and each fourth electrode plate changes;
the third electrode plate, the second conductor plate, and each fourth electrode plate form one second target capacitor; the processor is further configured to obtain capacitance values of the plurality of second target capacitors and determine the rotation directions and angular positions of the joystick based at least on the capacitance values of the plurality of first target capacitors and the capacitance values of the plurality of second target capacitors.

7. The joystick device according to claim 2, wherein among the plurality of rotating shafts, the number of rotating shafts provided with the first rotating portion and the second rotating portion is two, and the two rotating shafts have different rotation directions.

8. The joystick device according to claim 2, wherein each of the plurality of rotating shafts is provided with the first rotating portion and the second rotating portion.

9. The joystick device according to claim 1, wherein the joystick device further comprises a button, and a dome switch is provided on a surface of the button away from the upper cover; a button area correspondingly connected to the dome switch is provided on the first surface of the circuit board.

10. An electronic equipment, comprising the joystick device according to claim 1.
